(19) United States
(12) Patent Application Publication
(10) Pub. No.: US 2026/0203198 A1
(43) Pub. Date: Jul. 16, 2026

(54) CLUSTER-BASED DATA TESTING

(71) Applicant: Capital One Services, LLC, McLean, VA (US)

(72) Inventors: Komal Krishna PANDAMANETI, Frisco, TX (US); Siva R. VEGESANA, Frisco, TX (US); Jorge CALDERON, Richardson, TX (US); Sairam KOMMIREDDY, Frisco, TX (US); Shiju MADATHIL SAMUEL, Frisco, TX (US)

(21) Appl. No.: 19/024,312

(22) Filed: Jan. 16, 2025

(51) Int. Cl. G06F 11/3668

(52) U.S. Cl. CPC G06F 11/3688

(57) ABSTRACT

In some implementations, a system may obtain a data set that includes a plurality of variable sets corresponding to respective entities. The system may input the data set into a machine learning (ML) model. The system may identify, using the ML model, a parent cluster of a set of the respective entities. The set of the respective entities may have one or more shared parent characteristics that are specific, among the respective entities, to the set of the respective entities based on the plurality of variable sets. The system may identify, using the ML model, a child cluster of a subset of the set of the respective entities. The subset of the set of the respective entities may have one or more shared child characteristics that are specific, among the respective entities, to the subset of the set of the respective entities based on the plurality of variable sets.

### BACKGROUND

A machine learning (ML) model is a type of artificial intelligence (AI) model that, once trained based on a given dataset, can be used to make predictions or classifications on new data. The training may involve iteratively adjusting internal parameters of the ML model to minimize prediction errors. After training, the ML model may generate a prediction or classification on the new data based on the internal parameters and an input.

### SUMMARY

Some implementations described herein relate to a system for cluster-based data testing. The system may include one or more memories and one or more processors communicatively coupled to the one or more memories. The one or more processors may be configured to obtain a candidate test data set that includes a plurality of variable sets corresponding to respective entities. The one or more processors may be configured to input the candidate test data set into an ML model. The one or more processors may be configured to identify, using the ML model, a parent cluster of a set of the respective entities, wherein the set of the respective entities have one or more shared parent characteristics that are specific, among the respective entities, to the set of the respective entities based on the plurality of variable sets. The one or more processors may be configured to identify, using the ML model, a child cluster of a subset of the set of the respective entities, wherein the subset of the set of the respective entities have one or more shared child characteristics that are specific, among the respective entities, to the subset of the set of the respective entities based on the plurality of variable sets. The one or more processors may be configured to identify one or more variable sets of the plurality of variable sets corresponding to the subset of the set of the respective entities. The one or more processors may be configured to perform a testing validation of the one or more variable sets. The one or more processors may be configured to generate, responsive to the testing validation, one or more test feature files using the one or more variable sets. The one or more processors may be configured to execute the one or more test feature files. The one or more processors may be configured to obtain, in response to executing the one or more test feature files, a test result associated with the subset of the set of the respective entities.

Some implementations described herein relate to a method of cluster-based data testing. The method may include obtaining a candidate test data set that includes a plurality of variable sets corresponding to respective entities. The method may include inputting the candidate test data set into an ML model. The method may include identifying, using the ML model, a parent cluster of a set of the respective entities, wherein the set of the respective entities have one or more shared parent characteristics that are specific, among the respective entities, to the set of the respective entities based on the plurality of variable sets. The method may include identifying, using the ML model, a child cluster of a subset of the set of the respective entities, wherein the subset of the set of the respective entities have one or more shared child characteristics that are specific, among the respective entities, to the subset of the set of the respective entities based on the plurality of variable sets. The method may include identifying one or more variable sets of the plurality of variable sets corresponding to the subset of the set of the respective entities. The method may include generating one or more test feature files using the one or more variable sets. The method may include executing the one or more test feature files. The method may include obtaining, in response to executing the one or more test feature files, a test result associated with the subset of the set of the respective entities.

Some implementations described herein relate to a non-transitory computer-readable medium that stores a set of instructions. The set of instructions, when executed by one or more processors of a device, may cause the device to obtain a candidate test data set that includes a plurality of variable sets corresponding to respective entities. The set of instructions, when executed by one or more processors of the device, may cause the device to input the candidate test data set into an ML model. The set of instructions, when executed by one or more processors of the device, may cause the device to identify, using the ML model, a parent cluster of a set of the respective entities, wherein the set of the respective entities have one or more shared parent characteristics that are specific, among the respective entities, to the set of the respective entities based on the plurality of variable sets. The set of instructions, when executed by one or more processors of the device, may cause the device to identify, using the ML model, a plurality of nested child clusters of respective subsets of the set of the respective entities, wherein the respective subsets of the set of the respective entities have one or more respective shared child characteristics that are specific, among the respective entities, to the respective subsets of the set of the respective entities based on the plurality of variable sets. The set of instructions, when executed by one or more processors of the device, may cause the device to identify one or more variable sets of the plurality of variable sets corresponding to the subset of the set of the respective entities. The set of instructions, when executed by one or more processors of the device, may cause the device to perform a testing validation of the one or more variable sets. The set of instructions, when executed by one or more processors of the device, may cause the device to generate, responsive to the testing validation, one or more test feature files using the one or more variable sets. The set of instructions, when executed by one or more processors of the device, may cause the device to execute the one or more test feature files. The set of instructions, when executed by one or more processors of the device, may cause the device to obtain, in response to executing the one or more test feature files, a test result associated with the subset of the set of the respective entities.

### BRIEF DESCRIPTION OF THE DRAWINGS

FIGS. 1A-1C are diagrams of an example associated with cluster-based data testing, in accordance with some embodiments of the present disclosure.

FIG. 2 is a diagram illustrating an example of training and using an ML model in connection with cluster-based data testing, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with cluster-based data testing, in accordance with some embodiments of the present disclosure.

FIG. 5 is a flowchart of an example process associated with cluster-based data testing, in accordance with some embodiments of the present disclosure.

### DETAILED DESCRIPTION

The following detailed description of example implementations refers to the accompanying drawings. The same reference numbers in different drawings may identify the same or similar elements.

Data processing platforms are generally tested for various scenarios (e.g., different combinations of data or parameters within a data set, such as unique states of entities within the data set) to help improve robustness and reliability. For example, new data processing platforms may be tested as part of a migration effort from legacy data processing platforms. For example, data may be extracted from the data set using one or more scenario-based queries and provided to the data processing platform, and an output of the data processing platform based on the extracted data may be analyzed. However, the tested scenarios are typically identified manually, which can often involve performing excessive manual data queries, data retrieval, and analysis, and thereby increase processing and memory resource consumption. Manually identifying and writing large quantities of scenario-based queries, test cases, and/or test feature files can decrease quality and reliability, and introduce defects into code in the test feature files, and may also require undue time, capacity, and effort on the part of software engineers. Moreover, vast quantities of possible scenarios and large volumes of data within the data set can further increase consumption of processing and memory resources. Furthermore, software engineers may be unable to identify all possible scenarios in a data set, which may limit the scenario coverage of the data processing platform.

Some implementations described herein leverage ML models to automatically identify scenarios in a data set for data testing. The ML model (e.g., artificial intelligence) may iteratively cluster entities within the data set until the ML model identifies a cluster of entities that correspond to a given scenario. For example, the ML model may identify a parent cluster that corresponds to all entities sharing a high-level characteristic, and a first child cluster within the parent cluster that includes entities sharing a lower-level characteristic, a second child cluster within the first child cluster that includes entities sharing a still lower-level characteristic, and so forth. In some examples, an identified scenario may be used to autonomously generate test cases for testing a performance of the data processing platform in the identified scenario. Thus, the ML model may help to automatically create and validate test cases (e.g., test feature files) through selectively identified scenario data. As a result, the ML model may contribute to a complete end-to-end test automation solution.

As a result, the ML model can reduce manual data queries, data retrieval, and analysis, and, thus, help to mitigate consumption of processing and memory resources. For example, the ML model can significantly reduce consumption of processing and memory resources in cases involving large quantities of possible scenarios and/or data. The ML model can also identify scenarios that would otherwise not have been identified manually, which may enhance the overall testing process and help to improve the performance of the data processing platform. Furthermore, the ML model may reduce human intervention, which may enable software engineers to re-allocate resources (e.g., time and effort) to other projects. Automatically creating the test feature files may help to ensure quality, reliability, and defect-free code in the test feature files.

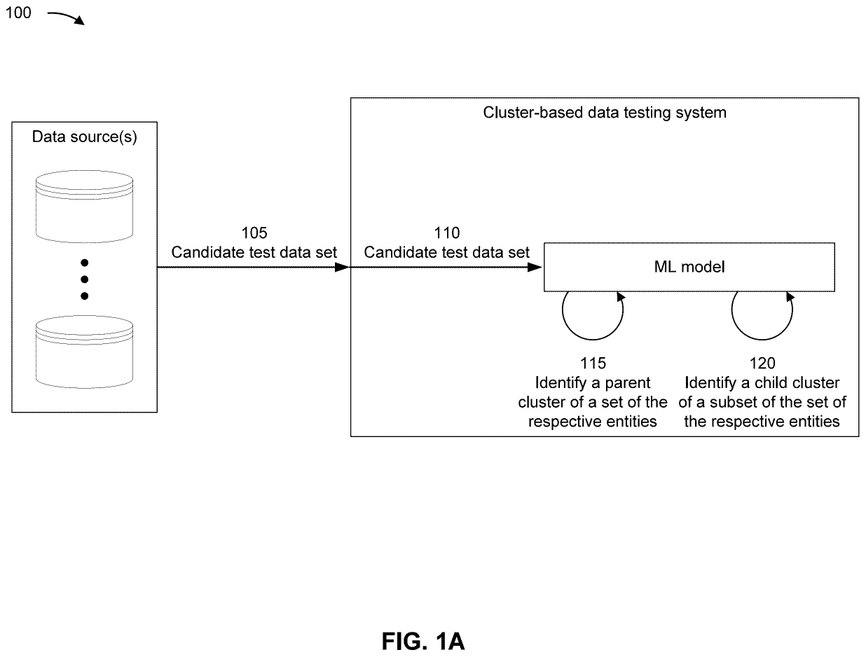

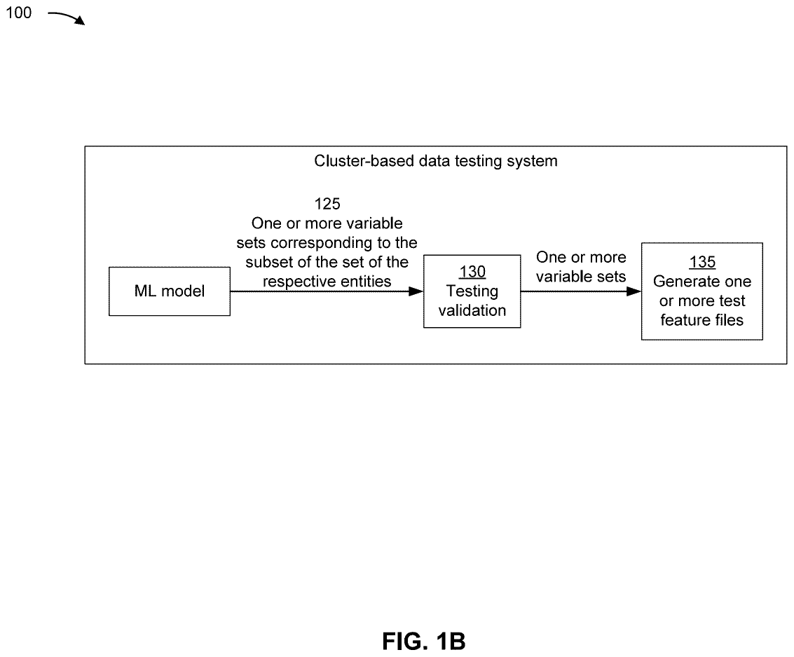

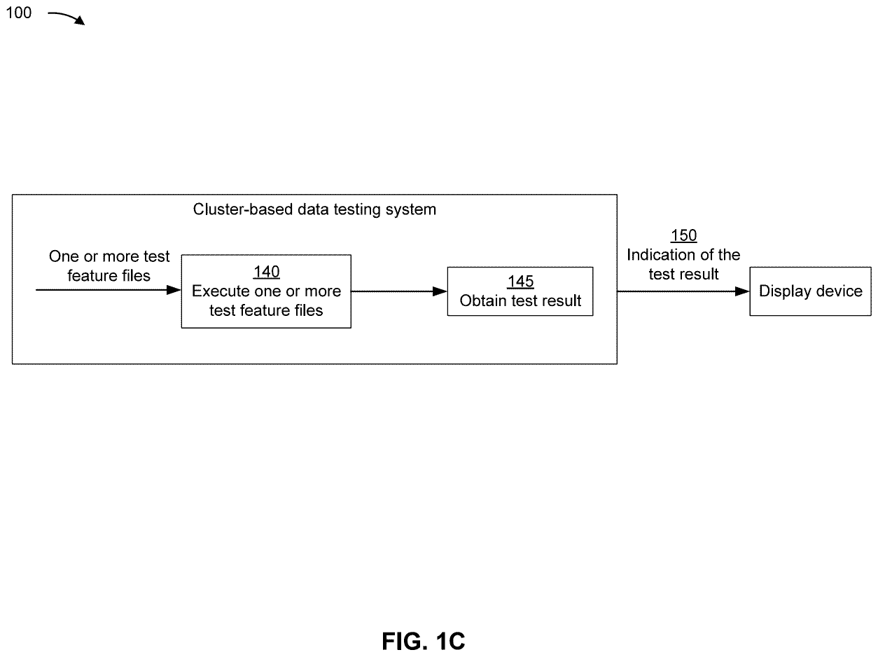

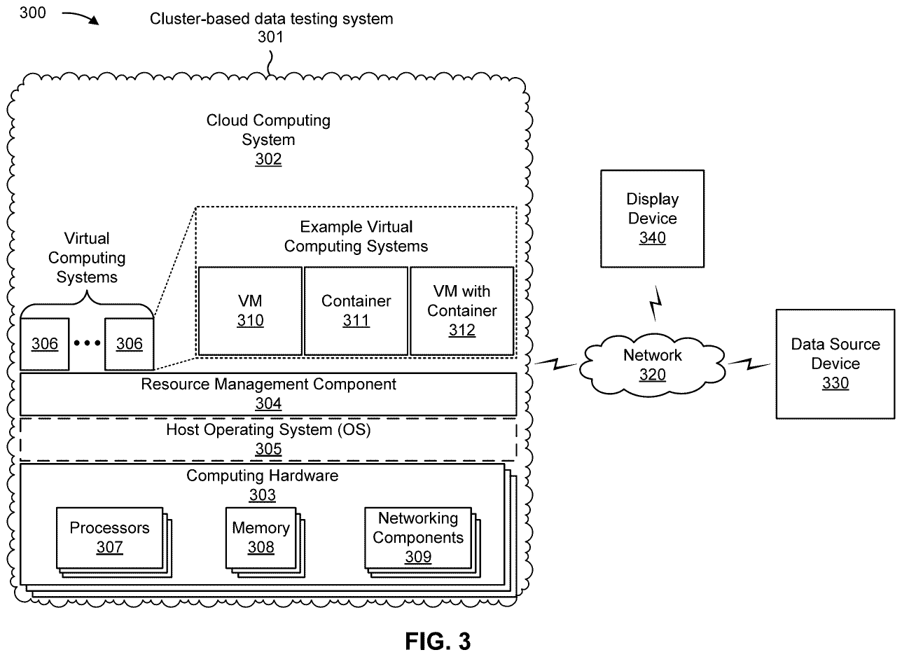

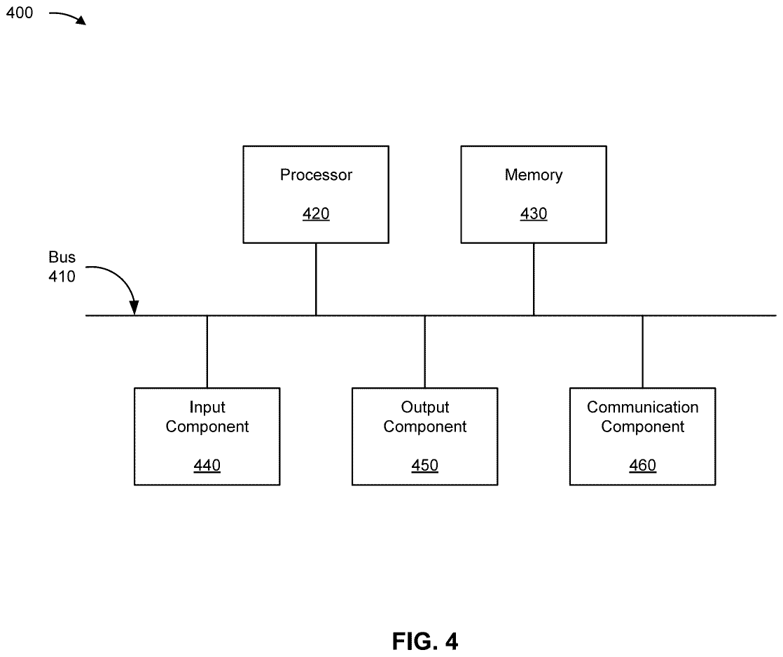

FIGS. 1A-1C are diagrams of an example 100 associated with cluster-based data testing. As shown in FIGS. 1A-1C, example 100 includes data sources, a cluster-based data testing system, and a display device. These devices are described in more detail in connection with FIGS. 3 and 4. Briefly, FIGS. 1A and 1B illustrate a one-time, up-front test data setup that covers various scenarios identified by an ML model, and FIG. 1C illustrates testing based on the one-time test data setup.

With reference to FIG. 1A, as shown by reference number 105, the cluster-based data testing system may obtain a candidate test data set that includes a plurality of variable sets corresponding to respective entities. A variable set may include multiple data values in respective data fields. For example, the data values may include account data, transaction data, or the like. Each entity may be associated with a given set of values within the candidate test data set. In some examples, an entity may represent a user. In some examples, the cluster-based data testing system may obtain the candidate test data set from one or more data sources, such as one or more databases, applications, or the like. In some examples, the cluster-based data testing system may perform data mining and/or data extraction on the candidate test data set.

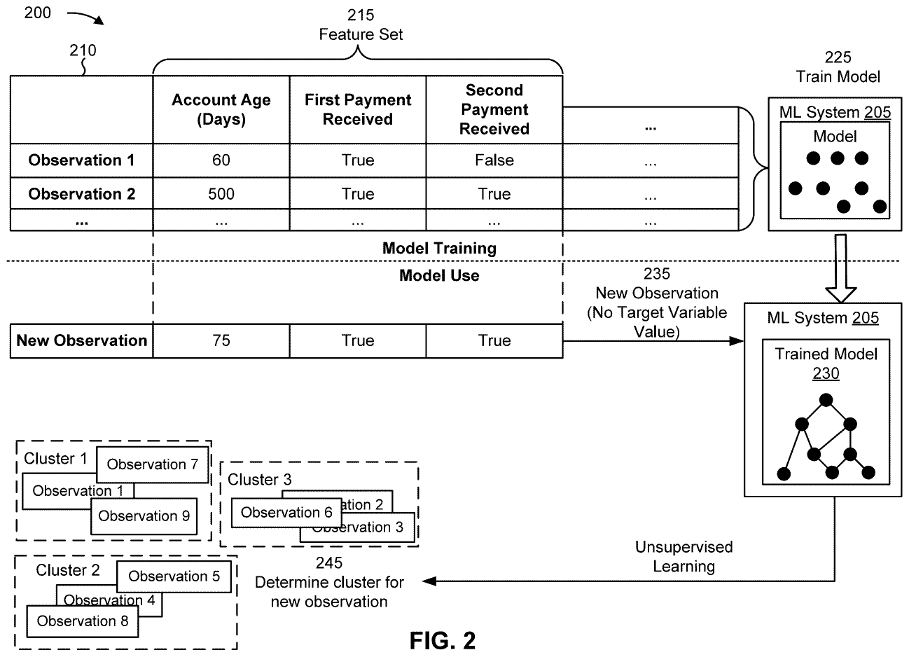

As shown by reference number 110, the cluster-based data testing system may input the candidate test data set into an ML model. The ML model may be configured to take data as input and output scenarios identified in the data. For example, the ML model may be configured to identify different scenarios within the candidate test data set using clustering. The ML model is described in greater detail below in connection with FIG. 2.

As shown by reference number 115, the cluster-based data testing system may identify, using the ML model, a parent cluster of a set of the respective entities. For example, the parent cluster may include a plurality of entities. The set of the respective entities may have one or more shared parent characteristics that are specific, among the respective entities, to the set of the respective entities based on the plurality of variable sets. For example, the parent characteristics may be unique to the entities within the parent cluster such that other entities in, or associated with, the candidate test data set do not have the parent characteristics. For example, the entities in the parent cluster may have a similarity (e.g., the parent characteristics) between each other and not with other entities in the candidate test data set. In some examples, the parent characteristics may correspond to specific data values or combinations thereof.

As shown by reference number 120, the cluster-based data testing system may identify, using the ML model, a child cluster of a subset of the set of the respective entities. For example, the child cluster may include a subset of the entities in the parent cluster. The subset of entities may have one or more shared child characteristics that are specific, among the respective entities, to the subset of the set of the respective entities based on the plurality of variable sets. For example, the child characteristics may be unique to the entities within the subset of entities such that other entities in the parent cluster do not have the child characteristics. For example, the entities in the child cluster may have a similarity (e.g., the child characteristics) between each other and not with other entities in the parent cluster. In some examples, the child characteristics may correspond to specific data values or combinations thereof. In this manner, the ML model may iteratively cluster entities to identify a group of entities, such as the child cluster, that represent a particular scenario (e.g., specific data values or combinations thereof).

In some aspects, the child cluster may be one of a plurality of nested child clusters of respective nested subsets of the set of the respective entities. For example, the ML model may identify a subset of entities in the child cluster having one or more shared characteristics that are specific, among the entities in the child cluster, to the subset of entities in the child cluster. For example, the shared characteristics may be unique to the entities within the subset of entities in the child cluster such that other entities in the in the child cluster do not have the shared characteristics. For example, the subset of entities in the child cluster may have a similarity (e.g., the shared characteristics) between each other and not with other entities in the child cluster. In this manner, the ML model may iteratively cluster entities to identify a group of entities, such as a lowest-level nested child cluster, that represent a particular scenario (e.g., specific data values or combinations thereof).

With reference to FIG. 1B, as shown by reference number 125, the cluster-based data testing system may identify one or more variable sets of the plurality of variable sets corresponding to the subset of the set of the respective entities. For example, the cluster-based data testing system may identify the data values corresponding to the entities that are identified as belonging to the child cluster. For example, the cluster-based data testing system may identify the data values (e.g., test scenario data) corresponding to entities associated with a particular scenario.

As shown by reference number 130, the cluster-based data testing system may perform a testing validation of the one or more variable sets. For example, the cluster-based data testing system may confirm a quality of the data in the one or more variable sets. For example, the cluster-based data testing system may automatically perform operations (e.g., replay transactions) in a specific order to verify the reliability of the data.

In some aspects, the cluster-based data testing system may input the one or more variable sets into a processing platform (e.g., a data processing platform) and obtain, from the processing platform, a valid output based on the one or more variable sets. For example, the processing platform may ingest the data (e.g., the one or more variable sets), process the data, and generate post-processed data (e.g., the valid output) that can be used to validate the one or more variable sets.

As shown by reference number 135, the cluster-based data testing system may generate, responsive to the testing validation, one or more test feature files using the one or more variable sets. The phrase “responsive to” and similar language is not intended to be limited to immediate responses that do not have any intervening events, and is intended to also cover delayed responses that occur after one or more intervening events. A test feature file may indicate the one or more variable sets (e.g., the test feature file may point to the test data (e.g., source data) that is relevant to the identified scenario to be tested). A test feature file may also indicate the scenario or test case corresponding to the one or more variable sets, define one or more operations for testing the features (e.g., which may include testing the one or more variable sets), or the like. In some examples, the cluster-based data testing system may automatically generate the test feature file(s). In some examples, the cluster-based data testing system may store, or cause to be stored, all test feature files corresponding to automatically identified scenarios. In some examples, the test feature file(s) may be written in Gherkin programming language.

In some aspects, the one or more test feature files may be one or more acceptance test-driven development (ATDD) files. For example, the ATDD file(s) may indicate one or more operations for acceptance testing to be carried out on the one or more variable sets. For example, the ATDD file(s) may help to determine whether the processing platform satisfies one or more acceptance criteria, which may indicate whether the processing platform can handle the one or more scenarios identified by the ML model.

In some aspects, the one or more test feature files may be associated with regression testing. The one or more test feature files may be associated with regression testing in that the one or more test feature files may be used for regression testing (e.g., as part of a regression testing workflow). “Regression testing” refers to testing a new version of software to verify whether the new version negatively impacts features of the previous version of the software. For example, the one or more test feature files may be used as part of regression testing for the processing platform. Thus, the one or more test feature files may support robust scenario-based regression testing. Additionally, or alternatively, the one or more test feature files may be used for release validation, smoke testing, or the like.

With reference to FIG. 1C, as shown by reference number 140, the cluster-based data testing system may execute the one or more test feature files. For example, the test feature file(s) may be integrated (e.g., input) into a software build pipeline that reads and executes the test feature file(s). In some examples, the software build pipeline may be an ATDD pipeline for automated testing. For example, the cluster-based data testing system may perform targeted scenario-based execution of ATDD test feature files. The ATDD pipeline may support scenario-based automated regression testing using an ATDD framework.

As shown by reference number 145, the cluster-based data testing system may obtain, in response to executing the one or more test feature files, a test result associated with the subset of the set of the respective entities. The test result may be associated with the subset of the set of the respective entities in that the test result may indicate whether the processing platform can handle scenarios identified in relation to the subset of the set of the respective entities. The test result may include a pass/fail indication, a success rate of tests, or any other suitable output.

As shown by reference number 150, the cluster-based data testing system may cause display of an indication of the test result associated with the subset of the set of the respective entities. For example, the cluster-based data testing system may report the test result by transmitting an indication of the test result to a display device, which may display the test result. For example, the display device may integrate the test result into a dashboard for monitoring. In some examples, the display device may display pass/fail indication, a success rate of tests, or the like.

In some aspects, the test result associated with the subset of the set of the respective entities may be based on one or more acceptance criteria associated with the one or more test feature files. Acceptance criteria may be conditions (e.g., thresholds or the like) that, if satisfied, establish that the processing platform can handle the identified scenario(s) according to the test result. The one or more acceptance criteria may be associated with the one or more test feature files in that the test feature files may be executed in connection with the acceptance criteria. For example, an acceptance criterion may indicate whether a test performed using a test feature file indicates that the processing platform can handle the identified scenario.

Identifying the parent cluster using the ML model, the child cluster using the ML model, and the one or more variable sets may help to reduce manual data queries, data retrieval, and analysis, and, thus, help to mitigate consumption of processing and memory resources. For example, the ML model can significantly reduce consumption of processing and memory resources in cases involving large quantities of possible scenarios and/or data. The ML model can also identify scenarios that would otherwise not have been identified manually, which may enhance the overall testing process and help to improve the performance of the data processing platform. Furthermore, the ML model may reduce human intervention, which may enable software engineers to re-allocate resources (e.g., time and effort) to other projects. Additionally, or alternatively, generating the test feature files may help to ensure quality, reliability, and defect-free code in the test feature files.

As indicated above, FIGS. 1A-1C are provided as an example. Other examples may differ from what is described with regard to FIGS. 1A-1C.

FIG. 2 is a diagram illustrating an example 200 of training and using an ML model in connection with cluster-based data testing. The ML model training and usage described herein may be performed using an ML system 205. The ML system 205 may include or may be included in a computing device, a server, a cloud computing environment, or the like, such as the cluster-based data testing system described in more detail elsewhere herein.

As shown by reference number 210, an ML model may be trained using a set of observations. The set of observations may be obtained from training data (e.g., historical data), such as data gathered during one or more processes described herein. In some implementations, the machine learning system 205 may receive the set of observations (e.g., as input) from one or more data sources, as described elsewhere herein.

As shown by reference number 215, the set of observations may include a feature set. The feature set may include a set of variables, and a variable may be referred to as a feature. A specific observation may include a set of variable values (or feature values) corresponding to the set of variables. In some implementations, the ML system 205 may determine variables for a set of observations and/or variable values for a specific observation based on input received from one or more data sources. For example, the ML system 205 may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of account age, a second feature of first payment reception, a third feature of second payment reception, and so on. As shown, for a first observation, the first feature may have a value of 30, the second feature may have a value of “True”, the third feature may have a value of “True”, and so on. These features and feature values are provided as examples, and may differ in other examples. For example, the feature set may include one or more of the following features: additional payment receptions, whether a payment is a full payment or a partial payment, a payment amount, a due date, a bankruptcy status, or the like.

In some implementations, the ML model may be an unsupervised learning model. In this case, the ML model may learn patterns from the set of observations without labeling or supervision, and may provide output that indicates such patterns, such as by using clustering and/or association to identify related groups of items within the set of observations.

As shown by reference number 225, the ML system 205 may train an ML model using the set of observations and using one or more ML algorithms, such as a regression algorithm, a decision tree algorithm, a neural network algorithm, a k-nearest neighbor algorithm, a support vector machine algorithm, or the like. After training, the ML system 205 may store the ML model as a trained ML model 230 to be used to analyze new observations.

As an example, the ML system 205 may obtain training data for the set of observations based on entity data. For example, an entity may be an account of a user, and the entity data may include account and/or transaction data or the like. In some examples, the training data may be obtained from large data sets (e.g., databases) of entity data.

As shown by reference number 235, the ML system 205 may apply the trained ML model 230 to a new observation, such as by receiving a new observation and inputting the new observation to the trained ML model 230. As shown, the new observation may include a first feature of account age, a second feature of first payment reception, a third feature of second payment reception, and so on, as an example. The ML system 205 may apply the trained ML model 230 to the new observation to generate an output (e.g., a result). The type of output may depend on the type of ML model and/or the type of ML task being performed. For example, the output may include information that identifies a cluster to which the new observation belongs and/or information that indicates a degree of similarity between the new observation and one or more other observations, such as when unsupervised learning is employed.

In some implementations, the trained ML model 230 may classify (e.g., cluster) the new observation in a cluster, as shown by reference number 245. The observations within a cluster may have a threshold degree of similarity. As an example, if the ML system 205 classifies the new observation in a first cluster (e.g., new accounts in good standing), then the ML system 205 may perform a first automated action and/or may cause a first automated action to be performed (e.g., by instructing another device to perform the automated action) based on classifying the new observation in the first cluster, such as generating a first test feature file. As another example, if the ML system 205 were to classify the new observation in a second cluster (e.g., new account in poor standing), then the ML system 205 may perform or cause performance of a second (e.g., different) automated action, such as generating a second test feature file. In some implementations, the automated action associated with the new observation may be based on a cluster in which the new observation is classified.

In some implementations, the trained ML model 230 may be re-trained using feedback information. For example, feedback may be provided to the ML model. The feedback may be associated with automated actions performed, or caused, by the trained ML model 230. In other words, the actions output by the trained ML model 230 may be used as inputs to re-train the ML model (e.g., a feedback loop may be used to train and/or update the ML model). For example, the feedback information may include whether a scenario was properly identified.

In this way, the ML system 205 may apply a rigorous and automated process to data testing. The ML system 205 may enable recognition and/or identification of tens, hundreds, thousands, or millions of features and/or feature values for tens, hundreds, thousands, or millions of observations, thereby increasing accuracy and consistency and reducing delay associated with data testing relative to requiring computing resources to be allocated for tens, hundreds, or thousands of operators to manually test data using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a cluster-based data testing system 301, which may include one or more elements of and/or may execute within a cloud computing system 302. The cloud computing system 302 may include one or more elements 303-312, as described in more detail below. As further shown in FIG. 3, environment 300 may include a network 320, a data source device 330, and/or a display device 340. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the cluster-based data testing system 301 may include one or more elements 303-312 of the cloud computing system 302, may execute within the cloud computing system 302, and/or may be hosted within the cloud computing system 302, in some implementations, the cluster-based data testing system 301 may not be cloud-based (e.g., may be implemented outside of a cloud computing system) or may be partially cloud-based. For example, the cluster-based data testing system 301 may include one or more devices that are not part of the cloud computing system 302, such as the device 400 of FIG. 4, which may include a standalone server or another type of computing device. The cluster-based data testing system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data source device 330 may include one or more devices capable of receiving, generating, storing, processing, and/or providing information associated with cluster-based data testing, as described elsewhere herein. The data source device 330 may include a communication device and/or a computing device. For example, the data source device 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source device 330 may communicate with one or more other devices of environment 300, as described elsewhere herein.

The display device 340 may include one or more devices capable of receiving, generating, storing, processing, and/or providing information associated with cluster-based data testing, as described elsewhere herein. The display device 340 may include a display, such as a screen. For example, the display device 340 may include a monitor, a wireless communication device, a mobile phone, a user equipment, a laptop computer, a tablet computer, a desktop computer, or a similar type of device. The display device 340 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with cluster-based data testing. The device 400 may correspond to cluster-based data testing system 301, data source device 330, and/or display device 340. In some implementations, cluster-based data testing system 301, data source device 330, and/or display device 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

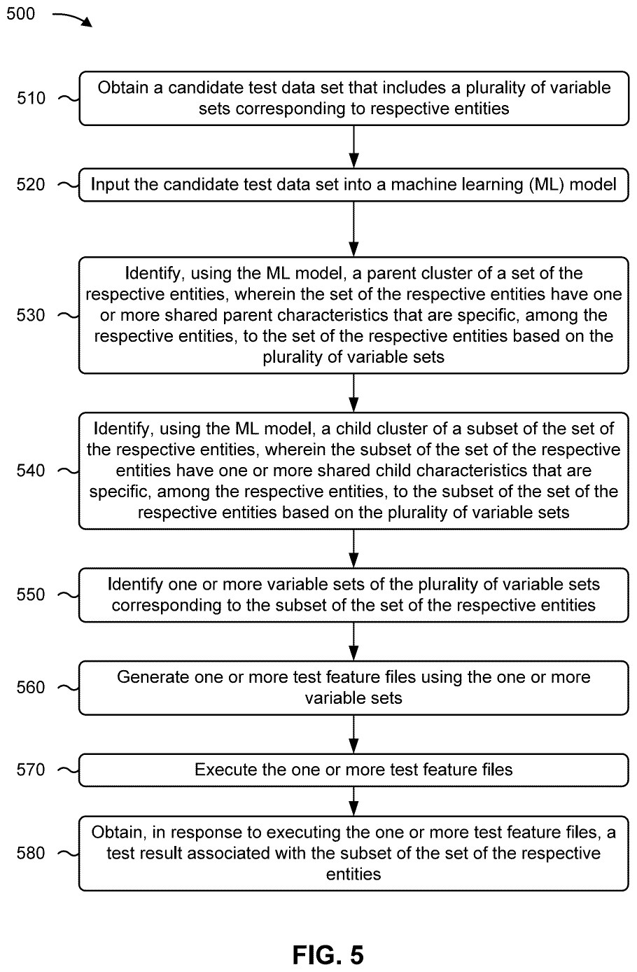

FIG. 5 is a flowchart of an example process 500 associated with cluster-based data testing. In some implementations, one or more process blocks of FIG. 5 may be performed by the cluster-based data testing system (e.g., the cluster-based data testing system 301). In some implementations, one or more process blocks of FIG. 5 may be performed by another device or a group of devices separate from or including the cluster-based data testing system, such as the data source device 330 and/or display device 340 Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include obtaining a candidate test data set that includes a plurality of variable sets corresponding to respective entities (block 510). For example, the cluster-based data testing system (e.g., using processor 420 and/or memory 430) may obtain a candidate test data set that includes a plurality of variable sets corresponding to respective entities, as described above in connection with reference number 105 of FIG. 1A. As an example, the cluster-based data testing system may obtain the candidate test data set from one or more data sources, such as one or more databases, applications, or the like.

As further shown in FIG. 5, process 500 may include inputting the candidate test data set into an ML model (block 520). For example, the cluster-based data testing system (e.g., using processor 420 and/or memory 430) may input the candidate test data set into an ML model, as described above in connection with reference number 110 of FIG. 1A. As an example, the ML model may be configured to identify different scenarios within the candidate test data set using clustering.

As further shown in FIG. 5, process 500 may include identifying, using the ML model, a parent cluster of a set of the respective entities (block 530). In some implementations, the set of the respective entities may have one or more shared parent characteristics that are specific, among the respective entities, to the set of the respective entities based on the plurality of variable sets. For example, the cluster-based data testing system (e.g., using processor 420 and/or memory 430) may identify, using the ML model, a parent cluster of a set of the respective entities, as described above in connection with reference number 115 of FIG. 1A. As an example, the entities in the parent cluster may have a similarity (e.g., the parent characteristics) between each other and not with other entities in the candidate test data set.

As further shown in FIG. 5, process 500 may include identifying, using the ML model, a child cluster of a subset of the set of the respective entities (block 540). In some implementations, the subset of the set of the respective entities may have one or more shared child characteristics that are specific, among the respective entities, to the subset of the set of the respective entities based on the plurality of variable sets. For example, the cluster-based data testing system (e.g., using processor 420 and/or memory 430) may identify, using the ML model, a child cluster of a subset of the set of the respective entities, as described above in connection with reference number 120 of FIG. 1A. As an example, the entities in the child cluster may have a similarity (e.g., the child characteristics) between each other and not with other entities in the parent cluster.

As further shown in FIG. 5, process 500 may include identifying one or more variable sets of the plurality of variable sets corresponding to the subset of the set of the respective entities (block 550). For example, the cluster-based data testing system (e.g., using processor 420 and/or memory 430) may identify one or more variable sets of the plurality of variable sets corresponding to the subset of the set of the respective entities, as described above in connection with reference number 125 of FIG. 1B. As an example, the cluster-based data testing system may identify the testing data corresponding to entities associated with a particular scenario.

As further shown in FIG. 5, process 500 may include generating one or more test feature files using the one or more variable sets (block 560). For example, the cluster-based data testing system (e.g., using processor 420 and/or memory 430) may generate one or more test feature files using the one or more variable sets, as described above in connection with reference number 135 of FIG. 1B. As an example, the test feature file may point to the testing data for the identified scenario to be tested.

As further shown in FIG. 5, process 500 may include executing the one or more test feature files (block 570). For example, the cluster-based data testing system (e.g., using processor 420 and/or memory 430) may execute the one or more test feature files, as described above in connection with reference number 140 of FIG. 1C. As an example, the one or more test feature files may be input into a software build pipeline that reads and executes the one or more test feature files.

As further shown in FIG. 5, process 500 may include obtaining, in response to executing the one or more test feature files, a test result associated with the subset of the set of the respective entities (block 580). For example, the cluster-based data testing system (e.g., using processor 420 and/or memory 430) may obtain, in response to executing the one or more test feature files, a test result associated with the subset of the set of the respective entities, as described above in connection with reference number 145 of FIG. 1C. As an example, the cluster-based data testing system may report the test result by transmitting an indication of the test result to a display device, which may display the test result.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C or 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for cluster-based data testing, the system comprising:
one or more memories; and
one or more processors, communicatively coupled to the one or more memories, configured to:
obtain a candidate test data set that includes a plurality of variable sets corresponding to respective entities;
input the candidate test data set into a machine learning (ML) model;
identify, using the ML model, a parent cluster of a set of the respective entities, wherein the set of the respective entities have one or more shared parent characteristics that are specific, among the respective entities, to the set of the respective entities based on the plurality of variable sets;
identify, using the ML model, a child cluster of a subset of the set of the respective entities, wherein the subset of the set of the respective entities have one or more shared child characteristics that are specific, among the respective entities, to the subset of the set of the respective entities based on the plurality of variable sets;
identify one or more variable sets of the plurality of variable sets corresponding to the subset of the set of the respective entities;
perform a testing validation of the one or more variable sets;
generate, responsive to the testing validation, one or more test feature files using the one or more variable sets;
execute the one or more test feature files; and
obtain, in response to executing the one or more test feature files, a test result associated with the subset of the set of the respective entities.

2. The system of claim 1, wherein the child cluster is one of a plurality of nested child clusters of respective nested subsets of the set of the respective entities.

3. The system of claim 1, wherein the one or more test feature files are one or more acceptance test-driven development (ATDD) files.

4. The system of claim 1, wherein the one or more processors, to perform the testing validation of the one or more variable sets, are configured to:
input the one or more variable sets into a processing platform; and
obtain, from the processing platform, a valid output based on the one or more variable sets.

5. The system of claim 1, wherein the one or more test feature files are associated with regression testing.

6. The system of claim 1, wherein the one or more processors are further configured to:
cause display of an indication of the test result associated with the subset of the set of the respective entities.

7. The system of claim 1, wherein the test result associated with the subset of the set of the respective entities is based on one or more acceptance criteria associated with the one or more test feature files.

8. A method of cluster-based data testing, comprising:
obtaining a candidate test data set that includes a plurality of variable sets corresponding to respective entities;
inputting the candidate test data set into a machine learning (ML) model;
identifying, using the ML model, a parent cluster of a set of the respective entities, wherein the set of the respective entities have one or more shared parent characteristics that are specific, among the respective entities, to the set of the respective entities based on the plurality of variable sets;
identifying, using the ML model, a child cluster of a subset of the set of the respective entities, wherein the subset of the set of the respective entities have one or more shared child characteristics that are specific, among the respective entities, to the subset of the set of the respective entities based on the plurality of variable sets;
identifying one or more variable sets of the plurality of variable sets corresponding to the subset of the set of the respective entities;
generating one or more test feature files using the one or more variable sets;
executing the one or more test feature files; and
obtaining, in response to executing the one or more test feature files, a test result associated with the subset of the set of the respective entities.

9. The method of claim 8, wherein the child cluster is one of a plurality of nested child clusters of respective nested subsets of the set of the respective entities.

10. The method of claim 8, wherein the one or more test feature files are one or more acceptance test-driven development (ATDD) files.

11. The method of claim 8, further comprising:
inputting the one or more variable sets into a processing platform; and
obtaining, from the processing platform, a valid output based on the one or more variable sets.

12. The method of claim 8, wherein the one or more test feature files are associated with regression testing.

13. The method of claim 8, further comprising:
causing display of an indication of the test result associated with the subset of the set of the respective entities.

14. The method of claim 8, wherein the test result associated with the subset of the set of the respective entities is based on one or more acceptance criteria associated with the one or more test feature files.

15. A non-transitory computer-readable medium storing a set of instructions, the set of instructions comprising:
one or more instructions that, when executed by one or more processors of a device, cause the device to:
obtain a candidate test data set that includes a plurality of variable sets corresponding to respective entities;
input the candidate test data set into a machine learning (ML) model;
identify, using the ML model, a parent cluster of a set of the respective entities, wherein the set of the respective entities have one or more shared parent characteristics that are specific, among the respective entities, to the set of the respective entities based on the plurality of variable sets;
identify, using the ML model, a plurality of nested child clusters of respective subsets of the set of the respective entities, wherein the respective subsets of the set of the respective entities have one or more respective shared child characteristics that are specific, among the respective entities, to the respective subsets of the set of the respective entities based on the plurality of variable sets;
identify one or more variable sets of the plurality of variable sets corresponding to the subset of the set of the respective entities;
perform a testing validation of the one or more variable sets;
generate, responsive to the testing validation, one or more test feature files using the one or more variable sets;
execute the one or more test feature files; and
obtain, in response to executing the one or more test feature files, a test result associated with the subset of the set of the respective entities.

16. The non-transitory computer-readable medium of claim 15, wherein the one or more test feature files are one or more acceptance test-driven development (ATDD) files.

17. The non-transitory computer-readable medium of claim 15, wherein the one or more instructions, that cause the device to perform the testing validation of the one or more variable sets, cause the device to:
input the one or more variable sets into a processing platform; and
obtain, from the processing platform, a valid output based on the one or more variable sets.

18. The non-transitory computer-readable medium of claim 15, wherein the one or more test feature files are associated with regression testing.

19. The non-transitory computer-readable medium of claim 15, wherein the one or more instructions, when executed by the one or more processors, further cause the device to:
cause display of an indication of the test result associated with the subset of the set of the respective entities.

20. The non-transitory computer-readable medium of claim 15, wherein the test result associated with the subset of the set of the respective entities is based on one or more acceptance criteria associated with the one or more test feature files.
